(19) United States
(12) Patent Application Publication
(10) Pub. No.: US 2025/0185849 A1
(43) Pub. Date: Jun. 12, 2025

(54) Portable Food Grate Device

(71) Applicants: Charles Plautz, Zimmerman, MN (US); Wilma Plautz, Zimmerman, MN (US)

(72) Inventors: Charles Plautz, Zimmerman, MN (US); Wilma Plautz, Zimmerman, MN (US)

(21) Appl. No.: 18/966,385

(22) Filed: Dec. 3, 2024

Related U.S. Application Data
(60) Provisional application No. 63/607,661, filed on Dec. 8, 2023.

(51) Int. Cl. A47J 37/07; A47J 33/00; A47J 37/06

(52) U.S. Cl. CPC A47J 37/0786; A47J 33/00; A47J 37/0694

(57) ABSTRACT

A portable food grate device is disclosed that is a heater-attachable grate that receives food or canned food for heating. The portable food grate device comprises a grate component that provides a grate surface for cooking food. The grate component is secured to the portable heater via an adjustable support post, which is secured to the front of the portable heater. The grate component utilizes the warmth from the portable heater vents to elevate its temperature. Thus, the grate component can function as a grilling or warming surface for heating up food items.

### CROSS-REFERENCE TO RELATED APPLICATION

The present application claims priority to, and the benefit of, U.S. Provisional Application No. 63/607,661, which was filed on Dec. 8, 2023, and is incorporated herein by reference in its entirety.

### FIELD OF THE INVENTION

The present invention relates generally to the field of portable food grate devices. More specifically, the present invention relates to a grate attachment for portable heaters designed to warm up food while outdoors. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in portable food grate devices. Generally, people spending time outdoors while camping, hunting, fishing, etc., will inevitably get hungry and want to eat. However, most food consumed while outdoors consists of cold meals or packaged snacks. Accordingly, people may be looking for ways to consume a warm meal while hunting or fishing.

Further, since fishermen, campers and other outdoor enthusiasts have to transport gear to and from each temporary location, where they will spend time, the size, weight, and number of functions that a single apparatus can reliably perform are each very important. As a result, and whenever possible, any gear or apparatus will desirably serve as many purposes as possible, to decrease the amount of gear necessary to be transported. One way this may be achieved is by using a heat source such as a campfire or portable heater to also warm or cook food or water.

Accordingly, there is a demand for an improved portable food grate device that functions as a grilling surface to heat up food, canned food, and other items while outdoors. More particularly, there is a demand for a portable food grate device that eliminates the need to constantly consume cold meals or packaged snacks while hunting, fishing, camping, etc.

Therefore, there exists a long felt need in the art for a portable food grate device that provides users with a grate attachment for portable heaters, designed to warm up food while outdoors. There is also a long felt need in the art for a portable food grate device that allows users to install the grate on the front of the heater to utilize warmth from the vents to heat up the grate. Further, there is a long felt need in the art for a portable food grate device that functions as a grilling surface to heat up food, canned food and other items while outdoors. Moreover, there is a long felt need in the art for a device that eliminates the need to constantly consume cold meals or packaged snacks while hunting, fishing, camping, etc. Further, there is a long felt need in the art for a portable food grate device that allows the grate to extend up and be adjusted with a support post. Finally, there is a long felt need in the art for a portable food grate device that can be manufactured of food-grade metal.

The subject matter disclosed and claimed herein, in one embodiment thereof, comprises a portable food grate device. The device is a heater-attachable grate that receives food or canned food for heating. The portable food grate device comprises a grate component that provides a grate surface for cooking food. The grate component is secured to the portable heater via an adjustable support post, which is secured to the front of the portable heater. The grate component utilizes the warmth from the portable heater vents to elevate its temperature. Thus, the grate component can function as a grilling or warming surface for heating up food items.

In this manner, the portable food grate device of the present invention accomplishes all of the forgoing objectives and provides users with a device that allows users to install the grate on the front of portable heaters. The device is a grate component that functions as a grilling surface. The device can be manufactured of a food-grade metal material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable food grate device. The device is a heater-attachable grate that receives food or canned food for heating. The portable food grate device comprises a grate component that provides a grate surface for cooking food. The grate component is secured to the portable heater via a support post. The grate component utilizes the warmth from the portable heater vents to elevate its temperature. Thus, the grate component can function as a grilling or warming surface for heating up food items.

In one embodiment, the portable food grate device is a portable heater attachment used for grilling and cooking. More specifically, the present invention is a grilling and cooking grate assembly for users to attach to an existing portable heater, such as radiant propane heaters, or any other suitable portable heaters, which use a front protective grille over the heating element(s) for attachment of the device. Specifically, the conventional radiant propane heaters use common propane cylinders for fuel, with a radiant catalytic burner plate on their front face protected by a safety guard or grille made of steel wire or rod. Further, the grille has a grid of horizontal wires spaced vertically along its face.

In one embodiment, the portable food grate device comprises a grate component for placing the food items to be cooked. The grate component is a flat main cooking grate with a top surface, a bottom surface, opposing front and back ends, and opposing right and left sides. The cooking grate is approximately 0.093 gauge, but can be any suitable gauge as is known in the art. The grate component is typically configured in a rectangular configuration and measures approximately 10″×6″ but can be any suitable shape and size as is known in the art, depending on the needs and/or wants of a user.

Furthermore, the grate component has a flat main heat-conductive grate with a pattern of openings or slots interrupting the flat cooking surface, although the grate component surface could alternately be a solid, unbroken surface for some types of cooking or heating uses. Further, the grate component is preferably made entirely of heat-resistant and food-grade metal, steel being currently preferred, or of any other sufficiently rigid and heat-resistant/food-grade materials as is known in the art.

In one embodiment, the opposing front and back ends of the grate component each comprise a set of plates which are typically secured together and manufactured of sheet metal. Specifically, the device comprises a top plate positioned on the top surface of the grate component and a bottom plate positioned on the bottom surface of the grate component, wherein the top and the bottom plates are secured together via bolts, screws, etc., or any other suitable securing means as is known in the art. Further, the set of plates are rectangular in shape and extend across the front and back ends of the grate component, from side-to-side. Typically, the top and bottom plates are mirror images of each other, and are sized and shaped to be identical, but do not have to be, and the top and bottom plates can be different sizes and shapes, as long as they act to be secured together in use.

In one embodiment, the front end of the grate component is secured to a top of a portable heater. Typically, the set of top and bottom plates secured at the front end of the grate component is secured via cotter pins to the top of the portable heater, thus securing the grate component to the portable heater for use. Any suitable securing means can be used to secure the grate component to the top of the portable heater, as is known in the art.

In one embodiment, the back end of the grate component is secured to a proximal end of at least one support post. Typically, the support post is secured to an underside (i.e., bottom surface) of the grate component, specifically to the top and bottom plates secured at the back end of the grate component. The support post is secured via a pair of L-brackets which attach the proximal end of the support post to the pair of plates, with a screw threaded through the L-brackets and support post to make a hinge, allowing the support post to hinge up against the bottom surface of the grate component when not in use, then hinge down, away from the grate component to secure to a portable heater for use.

In one embodiment, the support post is a square rod with a proximal and distal end and a length extending from approximately 1-3 feet but can be any suitable shape and size as is known in the art, depending on the wants and/or needs of a user and/or the size of the portable heater being used. The support post can be hollow and contain an open interior or be a solid rod. Further, the distal end of the support post comprises a support component with a channel or slot along its length. The channel/slot is sized and shaped to engage at least one rung (i.e., one or more of the horizontal wires) on the front protective grille over the heating element(s) of the portable heater. Thus, when the support post is extended away from the grate component, the support component engages and releasably secures to one or more of the horizontal wires of the portable heater, allowing the grate component to be secured in a horizontal configuration for use. Accordingly, the channel/slot allows a user to move the support post up and down along the front of the portable heater, in order to position the support post such that the grate component extends out horizontally from the portable heater, for use.

In one embodiment, there are two support posts that are secured to the grate component and then releasably secured to the portable heater for use. However, any suitable number of support posts can be utilized as is known in the art, depending on the size and shape of the portable heater being used.

In one embodiment, the at least one support post is telescoping. Specifically, the support post comprises at least one telescoping segment that allows the total length of the support post to be extended or retracted. Each telescoping segment is hollow and has a slip lock for locking the segment at a specific length. Further, the slip lock is released by means of pressing or turning the slip lock. The at least one telescoping segments allow the support post to have a length from approximately one to three feet fully extended, allowing a user to set the support post at a desired height. Thus, the support post is approximately one foot in height but can be adjusted to a height of approximately three feet, if needed.

In one embodiment, the bottom surface of the grate component comprises an attachment component that engages the distal end of the support post to secure it to the grate component, when not in use. Thus, the attachment component is configured to receive and secure the support post to the grate component when the grate component and the support post are not being used and being stored vertically.

Specifically, when the grate component is deployed horizontally from the heater grille, the support component is configured to engage a lower part of the protective grille of the portable heater, allowing the support post to extend down and support the grate component in the horizontal configuration. Furthermore, when the grate component is deployed vertically from the heater grille, the support component is configured to engage the attachment component to secure the support post against the grate component when the grate component and the support post are stored vertically on their own or against the heater grille.

In use, the grate component is assembled or deployed on the portable heater by engaging the front end of the grate component to the top of the portable heater via a set of plates screwed into the heater top. The support post is then dis-engaged from the attachment component and extended down, away from the grate component and releasably secured to a horizontal wire on the grille of the portable heater via the support component, such that the horizontal wire supports an outer end of the grate component via the support post. This allows the grate component to be positioned horizontally relative to the substantially vertical front of the portable heater. Food items can then be positioned on the grate component to be grilled and/or warmed for consumption. Accordingly, the grate component utilizes the warmth from the portable heater vents to elevate its surface temperature, to grill and/or warm the food items.

Furthermore, the grate component can be disassembled from its horizontal deployed state by simply reversing the order of assembly. The support post can then be folded up flush with the grate component and secured via the attachment component for storage or transport.

In yet another embodiment, the portable food grate device comprises a plurality of indicia.

In yet another embodiment, a method of heating up food or canned food via a portable heater is disclosed. The method includes the steps of providing a portable food grate device comprising a grate component with a support post. The method also comprises securing the end of the grate component to a top of a portable heater. Further, the method comprises extending out the support post from the grate component. The method also comprises securing the support post to a front of the portable heater to support the grate component in a horizontal position. Finally, the method comprises positioning food and canned food on the grate component surface to cook via heat from the portable heater.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the portable food grate device of the present invention showing the device applied to a portable heater in accordance with the disclosed architecture;

FIG. 2 illustrates a perspective view of one embodiment of the portable food grate device of the present invention showing the support post propping up the grate component on the portable heater in accordance with the disclosed architecture;

FIG. 3 illustrates a perspective view of one embodiment of the portable food grate device of the present invention showing the grate component in accordance with the disclosed architecture;

FIG. 4 illustrates a perspective view of one embodiment of the portable food grate device of the present invention showing the support post in accordance with the disclosed architecture;

FIG. 5 illustrates a perspective view of one embodiment of the portable food grate device of the present invention showing the support post secured to the grate component in accordance with the disclosed architecture; and

FIG. 6 illustrates a flowchart showing the method of heating up food or canned food via a portable heater in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a portable food grate device that provides users with a grate attachment for portable heaters, designed to warm up food while outdoors. There is also a long felt need in the art for a portable food grate device that allows users to install the grate on the front of the heater to utilize warmth from the vents to heat up the grate. Further, there is a long felt need in the art for a portable food grate device that functions as a grilling surface to heat up food, canned food and other items while outdoors. Moreover, there is a long felt need in the art for a device that eliminates the need to constantly consume cold meals or packaged snacks while hunting, fishing, camping, etc. Further, there is a long felt need in the art for a portable food grate device that allows the grate to extend up and be adjusted with a support post. Finally, there is a long felt need in the art for a portable food grate device that can be manufactured of food-grade metal.

The present invention, in one exemplary embodiment, is a novel portable food grate device. The portable food grate device comprises a grate component that provides a grate surface for cooking food. The grate component is secured to the portable heater via an adjustable support post, which is secured to the front of the portable heater. The grate component utilizes the warmth from the portable heater vents to elevate its temperature. Thus, the grate component can function as a grilling or warming surface for heating up food items. The present invention also includes a novel method of heating up food or canned food via a portable heater. The method includes the steps of providing a portable food grate device comprising a grate component with a support post. The method also comprises securing the end of the grate component to a top of a portable heater. Further, the method comprises extending out the support post from the grate component. The method also comprises securing the support post to a front of the portable heater to support the grate component in a horizontal position. Finally, the method comprises positioning food and canned food on the grate component surface to cook via heat from the portable heater.

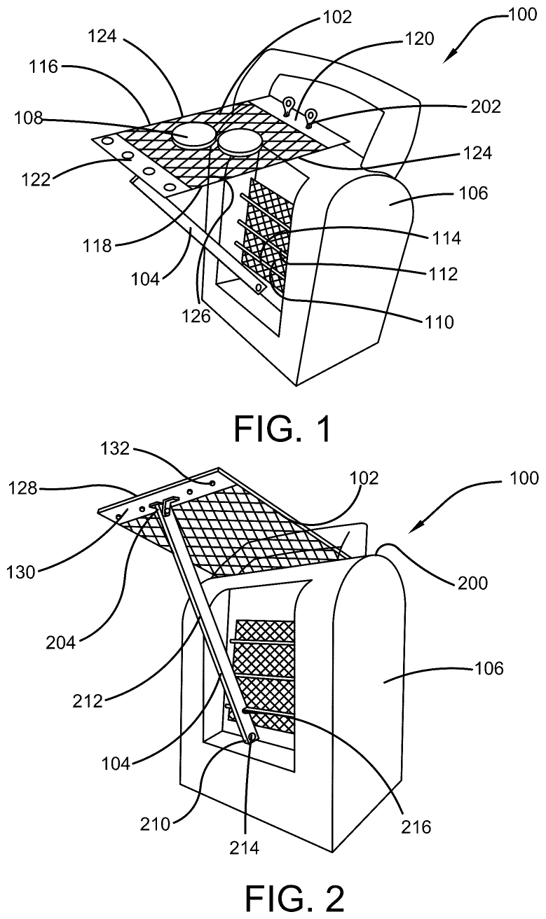

Referring initially to the drawings, FIG. 1 illustrates a perspective view of one embodiment of the portable food grate device 100 of the present invention. In the present embodiment, the portable food grate device 100 is an improved portable food grate device 100 that provides a user with a grate attachment for portable heaters 106 designed to warm up food 108 while outdoors. Specifically, the portable food grate device 100 comprises a grate component 102 with a support post 104, which secures the grate component 102 to the portable heater 106. The grate component 102 utilizes the warmth from the portable heater 106 vents to elevate its temperature. Thus, the grate component 102 can function as a grilling or warming surface for heating up food items 108.

Generally, the portable food grate device 100 is a portable heater attachment used for grilling and cooking. More specifically, the present invention is a grilling and cooking grate assembly for users to attach to an existing portable heater 106, such as radiant propane heaters, or any other suitable portable heaters, which use a front protective grille 110 over the heating element(s) 112 for attachment of the device 100. Specifically, the conventional radiant propane heaters use common propane cylinders for fuel, with a radiant catalytic burner plate on their front face protected by a safety guard or grille 110 made of steel wire or rod. Further, the grille 110 has a grid of horizontal wires 114 spaced vertically along its face.

Further, the portable food grate device 100 comprises a grate component 102 for placing the food items 108 to be cooked. The grate component 102 is a flat main cooking grate with a top surface 116, a bottom surface 118, opposing front 120 and back 122 ends, and opposing right and left sides 124. The cooking grate is approximately 0.093 gauge, but can be any suitable gauge as is known in the art. The grate component 102 is typically configured in a rectangular configuration and measures approximately 10″×6″ but can be any suitable shape and size as is known in the art, depending on the needs and/or wants of a user.

Furthermore, the grate component 102 has a flat main heat-conductive grate with a pattern of openings 126 or slots interrupting the flat cooking surface, although the grate component 102 surface could alternately be a solid, unbroken surface for some types of cooking or heating uses. Further, the grate component 102 is preferably made entirely of heat-resistant and food-grade metal, steel being currently preferred, or of any other sufficiently rigid and heat-resistant/food-grade materials as is known in the art.

Additionally, the opposing front 120 and back 122 ends of the grate component 102 each comprise a set of plates 128 and 130 which are typically secured together and manufactured of sheet metal. Specifically, the device 100 comprises a top plate 128 positioned on the top surface 116 of the grate component 102 and a bottom plate 130 positioned on the bottom surface 118 of the grate component 102, wherein the top 128 and the bottom 130 plates are secured together via bolts, screws 132, etc., or any other suitable securing means as is known in the art. Further, the set of plates 128 and 130 are rectangular in shape and extend across the front 120 and back 122 ends of the grate component 102, from side-to-side. Typically, the top 128 and bottom 130 plates are mirror images of each other, and are sized and shaped to be identical, but do not have to be, and the top 128 and bottom 130 plates can be different sizes and shapes, as long as they act to be secured together in use.

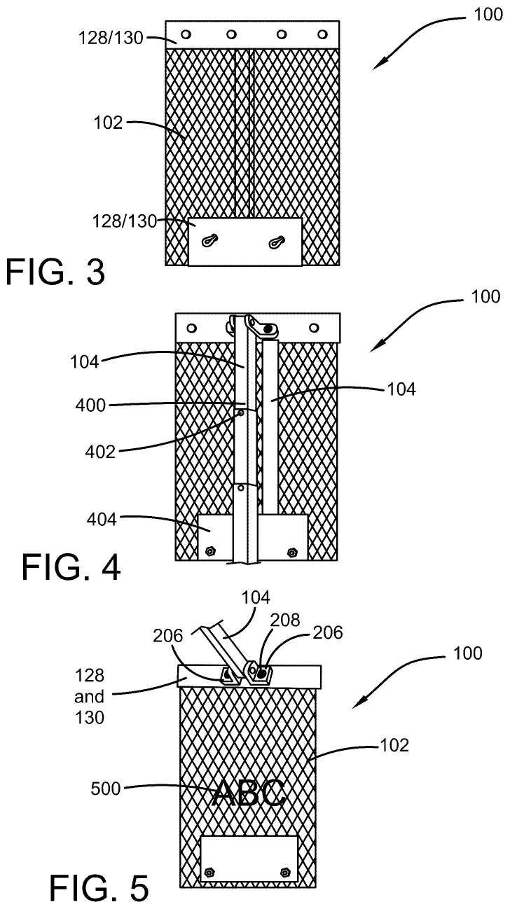

As shown in FIGS. 2-3, the front end 120 of the grate component 102 is secured to a top 200 of a portable heater 106. Typically, the set of top 128 and bottom 130 plates secured at the front end 120 of the grate component 102 is secured via cotter pins 202 to the top 200 of the portable heater 106, thus securing the grate component 102 to the portable heater 106 for use. Any suitable securing means can be used to secure the grate component 102 to the top 200 of the portable heater 106, as is known in the art.

Furthermore, the back end 122 of the grate component 102 is secured to a proximal end 204 of at least one support post 104. Typically, the support post 104 is secured to an underside (i.e., bottom surface 118) of the grate component 102, specifically to the top 128 and bottom 130 plates secured at the back end 122 of the grate component 102. The support post 104 is secured via a pair of L-brackets 206 which attach the proximal end 204 of the support post 104 to the pair of plates 128 and 130, with a screw 208 threaded through the L-brackets 206 and support post 104 to make a hinge, allowing the support post 104 to hinge up against the bottom surface 118 of the grate component 102 when not in use, then hinge down, away from the grate component 102 to secure to a portable heater 106 for use.

Additionally, the support post 104 is a square rod with a proximal 204 and distal 210 end and a length 212 extending from approximately 1-3 feet but can be any suitable shape and size as is known in the art, depending on the wants and/or needs of a user and/or the size of the portable heater 106 being used. The support post 104 can be hollow and contain an open interior or be a solid rod. Further, the distal end 210 of the support post 104 comprises a support component 214 with a channel 216 or slot along its length. The channel/slot 216 is sized and shaped to engage at least one rung (i.e., one or more of the horizontal wires 114) on the front protective grille 110 over the heating element(s) 112 of the portable heater 106. Thus, when the support post 104 is extended away from the grate component 102, the support component 214 engages and releasably secures to one or more of the horizontal wires 114 of the portable heater 106, allowing the grate component 102 to be secured in a horizontal configuration for use. Accordingly, the channel/slot 216 allows a user to move the support post 104 up and down along the front of the portable heater 106, in order to position the support post 104 such that the grate component 102 extends out horizontally from the portable heater 106, for use.

As shown in FIG. 4, in one embodiment, there are two support posts 104 that are secured to the grate component 102 and then releasably secured to the portable heater 106 for use. However, any suitable number of support posts 104 can be utilized as is known in the art, depending on the size and shape of the portable heater 106 being used.

Further, in another embodiment, the at least one support post 104 is telescoping. Specifically, the support post 104 comprises at least one telescoping segment 400 that allows the total length of the support post 104 to be extended or retracted. Each telescoping segment 400 is hollow and has a slip lock 402 for locking the segment 400 at a specific length. Further, the slip lock 402 is released by means of pressing or turning the slip lock 402. The at least one telescoping segments 400 allow the support post 104 to have a length 212 from approximately one to three feet fully extended, allowing a user to set the support post 104 at a desired height. Thus, the support post 104 is approximately one foot in height but can be adjusted to a height of approximately three feet, if needed.

In yet another embodiment, the bottom surface 118 of the grate component 102 comprises an attachment component 404 that engages the distal end 210 of the support post 104 to secure it to the grate component 102, when not in use. Thus, the attachment component 404 is configured to receive and secure the support post 104 to the grate component 102 when the grate component 102 and the support post 104 are not being used and being stored vertically.

Specifically, when the grate component 102 is deployed horizontally from the heater grille 110, the support component 214 is configured to engage a lower part of the protective grille 110 of the portable heater 106, allowing the support post 104 to extend down and support the grate component 102 in the horizontal configuration. Furthermore, when the grate component 102 is deployed vertically from the heater grille 110, the support component 214 is configured to engage the attachment component 404 to secure the support post 104 against the grate component 102 when the grate component 102 and the support post 104 are stored vertically on their own or against the heater grille 110.

As shown in FIG. 5, in use, the grate component 102 is assembled or deployed on the portable heater 106 by engaging the front end 120 of the grate component 102 to the top 200 of the portable heater 106 via a set of plates 128 and 130 screwed into the heater top 200. The support post 104 is then dis-engaged from the attachment component 404 and extended down, away from the grate component 102 and releasably secured to a horizontal wire 114 on the grille 110 of the portable heater 106 via the support component 214, such that the horizontal wire 114 supports an outer end of the grate component 102 via the support post 104. This allows the grate component 102 to be positioned horizontally relative to the substantially vertical front of the portable heater 106. Food items 108 can then be positioned on the grate component 102 to be grilled and/or warmed for consumption. Accordingly, the grate component 102 utilizes the warmth from the portable heater 106 vents to elevate its surface temperature, to grill and/or warm the food items 108.

Furthermore, the grate component 102 can be disassembled from its horizontal deployed state by simply reversing the order of assembly. The support post 104 can then be folded up flush with the bottom surface 118 of the grate component 102 and secured via the attachment component 404 for storage or transport.

In yet another embodiment, the portable food grate device 100 comprises a plurality of indicia 500. The grate component 102 of the device 100 may include advertising, a trademark, or other letters, designs, or characters, printed, painted, stamped, or integrated into the grate component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be grate, portable heater, or brand related.

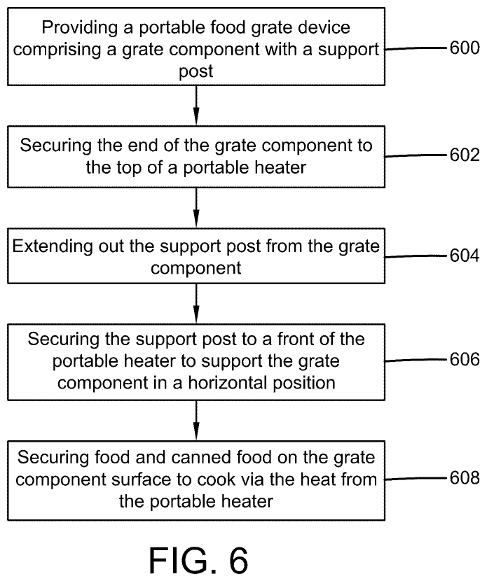

FIG. 6 illustrates a flowchart of the method of heating up food or canned food via a portable heater. The method includes the steps of at 600, providing a portable food grate device comprising a grate component with a support post. The method also comprises at 602, securing the end of the grate component to a top of a portable heater. Further, the method comprises at 604, extending out the support post from the grate component. The method also comprises at 606, securing the support post to a front of the portable heater to support the grate component in a horizontal position. Finally, the method comprises at 608, positioning food and canned food on the grate component surface to cook via heat from the portable heater.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “portable food grate device”, “grate device”, “food device”, and “device” are interchangeable and refer to the portable food grate device 100 of the present invention.

Notwithstanding the forgoing, the portable food grate device 100 of the present invention can be of any suitable size and configuration as is known in the art without affecting the overall concept of the invention, provided that it accomplishes the above stated objectives. One of ordinary skill in the art will appreciate that the portable food grate device 100 as shown in FIGS. 1-6 is for illustrative purposes only, and that many other sizes and shapes of the portable food grate device 100 are well within the scope of the present disclosure. Although the dimensions of the portable food grate device 100 are important design parameters for user convenience, the portable food grate device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable food grate device that provides a user with a grate attachment for portable heaters designed to warm up food while outdoors, the portable food grate device comprising:
a grate component; and
a support post; and
wherein the support post is secured to a bottom surface of the grate component;
wherein the support post secures the grate component to a portable heater; and
further wherein the grate component utilizes warmth from the portable heater to elevate its surface temperature, to cook food items.

2. The portable food grate device of claim 1, wherein the portable heater is a radiant propane heater with a front protective grille of horizontal wires positioned over a heating element for attachment of the portable food grate device.

3. The portable food grate device of claim 2, wherein the grate component is a flat cooking grate with a top surface, a bottom surface, opposing front and back ends, and opposing right and left sides.

4. The portable food grate device of claim 3, wherein the grate component has a pattern of openings or a solid, unbroken surface.

5. The portable food grate device of claim 4, wherein the grate component is made of heat-resistant and food-grade metal.

6. The portable food grate device of claim 5, wherein the opposing front and back ends of the grate component each comprise a top plate positioned on the top surface of the grate component and a bottom plate positioned on the bottom surface of the grate component, which are secured together via screws and extend across the front and back ends of the grate component, from side-to-side.

7. The portable food grate device of claim 6, wherein the front end of the grate component is secured via the top and bottom plates to a top of the portable heater via a set of cotter pins.

8. The portable food grate device of claim 7, wherein the back end of the grate component is secured to a proximal end of the support post via a pair of L-brackets positioned on the bottom surface, which attach the proximal end of the support post to the top and bottom plates with a screw threaded through to make a hinge, allowing the support post to hinge up against the bottom surface of the grate component when not in use.

9. The portable food grate device of claim 8, wherein the support post is a square rod with a proximal and distal end and a length extending from approximately 1-3 feet.

10. The portable food grate device of claim 9, wherein the distal end of the support post comprises a support component with a channel for engaging one or more of the horizontal wires on the front protective grille of the portable heater.

11. A portable food grate device that provides a user with a grate attachment for portable heaters designed to warm up food while outdoors, the portable food grate device comprising:
a grate component comprising a top surface, a bottom surface, opposing front and back ends, and opposing right and left sides; and
a support post which is a square rod with a proximal and distal end and a length extending from approximately 1-3 feet; and
wherein the opposing front and back ends of the grate component each comprise a top plate positioned on the top surface of the grate component and a bottom plate positioned on the bottom surface of the grate component, which are secured together via screws and extend across the front and back ends of the grate component, from side-to-side;
wherein the front end of the grate component is secured via the top and bottom plates to a top of the portable heater via a set of cotter pins;
wherein the back end of the grate component is secured to a proximal end of the support post via a pair of L-brackets positioned on the bottom surface, which attach the proximal end of the support post to the top and bottom plates with a screw threaded through to make a hinge, allowing the support post to hinge up against the bottom surface of the grate component when not in use;
wherein the distal end of the support post comprises a support component with a channel for engaging one or more of the horizontal wires on the front protective grille of the portable heater; and
wherein the grate component utilizes warmth from the portable heater to elevate its surface temperature, to cook food items.

12. The portable food grate device of claim 11, wherein more than one support posts are used to secure the grate component.

13. The portable food grate device of claim 11, wherein the support post is telescoping and comprises at least one telescoping segment and a slip lock that allows a total length of the support post to be extended or retracted, and then locked into place.

14. The portable food grate device of claim 11, wherein the bottom surface of the grate component comprises an attachment component that engages the distal end of the support post to secure it flush to the grate component, when not in use.

15. The portable food grate device of claim 11, wherein when the grate component is deployed horizontally from the portable heater, the support component is configured to engage a lower part of the portable heater, allowing the support post to extend down and support the grate component in the horizontal configuration.

16. The portable food grate device of claim 15, wherein when the grate component is deployed vertically from the portable heater, the support component is configured to engage the attachment component to secure the support post against the grate component when the grate component and the support post are stored vertically on their own or against the portable heater.

17. The portable food grade device of claim 11 further comprising a plurality of indicia.

18. The portable food grate device of claim 11, wherein the grate component is made of heat-resistant and food-grade metal.

19. The portable food grate device of claim 11, wherein the grate component has a pattern of openings or a solid, unbroken surface.

20. A method of heating up food or canned food via a portable heater, the method comprising the following steps:
providing a portable food grate device comprising a grate component with a support post;
securing the end of the grate component to a top of a portable heater;
extending out the support post from the grate component;
securing the support post to a front of the portable heater to support the grate component in a horizontal position; and
positioning food and canned food on the grate component surface to cook via heat from the portable heater.
